(19) United States
(12) Patent Application Publication
(10) Pub. No.: US 2012/0206093 A1
(43) Pub. Date: Aug. 16, 2012

(54) CHARGING APPARATUS FOR ELECTRIC ENERGY STORES, SUPPLY STATION, AND METHOD FOR CHARGING ELECTRIC ENERGY STORES

(75) Inventors: Tim Schaefer, Niedersachswerfen (DE); Andreas Gutsch, Luedinghausen (DE)

(73) Assignee: Li-Tec Battery GmbH, Kamenz (DE)

(21) Appl. No.: 13/386,301

(22) PCT Filed: Jul. 21, 2010
(86) PCT No.: PCT/EP2010/004472

§ 371 Date: Apr. 16, 2012

(30) Foreign Application Priority Data
Jul. 23, 2009 (DE) 10 2009 034 371.1

(51) Int. Cl. H02J 7/00

(52) U.S. Cl. 320/107; 320/137

(57) ABSTRACT

A charging apparatus for electric energy stores includes a holding device configured to accommodate one or a plurality of electric energy stores, or rechargeable electric energy stores for vehicles, a charging and charge control device configured to charge, in a controlled manner, the electric energy store(s) accommodated in the holding device, and an air-conditioning device configured to control the temperature inside the holding device. The air-conditioning device is further configured to adjust the air inside the holding device to the surrounding conditions with respect to the dew point.

The present invention relates to a charging device for electric energy stores, a supply station for supplying vehicles comprising electric energy stores, and a method for charging electric energy stores.

It is known to use electric current to drive vehicles, such as automobiles, motorcycles and boats. The electric current is carried on-board the vehicle in batteries or rechargeable batteries (in the automotive industry, rechargeable batteries are also widely referred to colloquially as batteries) and is used by way of an electric motor for driving. In recent years, lithium ion rechargeable batteries have become established as the high-capacity, heavy-duty foundation of electric vehicle drive systems. Initial considerations with respect to the comprehensive supply of such vehicles related to networks of self-charging stations where the vehicle batteries can be charged in the vehicle. Such networks are currently in evaluation and development.

From EP 0 902 348 A2 it is known to stockpile batteries for users for driving motorcycles in rental stations, in the form of a rental system or network. In these battery rental stations, batteries of a uniform size are accommodated in a thermally insulated and temperature-controlled compartment in which they are stored and charged. A temperature control section calculates a difference between an upper limit value and a lower limit value and the temperature inside the compartment or the temperature outside the station in order to calculate a control signal for a temperature controller. The temperature controller comprises a heating device and a cooling device and, depending on the control signal, supplies cool air or warm air into the compartment. The temperature limit values can be specified in an arbitrary manner, e.g. depending on the season of the year.

The “better place” project envisions a comprehensive network of electric filling stations comprising battery charging stations and battery exchange stations (manager-magazin.de, 30 Oct. 2007, “Das SAP-Wunderkind kehrt zuruck” [Return of the SAP Wunderkind], www.manager-magazin.de/it/artikel/0,2828,514273,00.html). According thereto, exchange stations are provided for stockpiling, charging, and maintaining the charge of many types of vehicle batteries, and for exchanging a dead battery of a vehicle for a fully charged battery in a short period of time.

The logistics and management of the inventory of rechargeable batteries and the state of charge of the rechargeable batteries are decisive factors for the operability of an infrastructure of such rechargeable battery exchange stations. It must be noted that there are different vehicle types having different requirements on the capacity of the rechargeable battery. A particular challenge is that of always having freshly charged batteries on hand as replacements for the various vehicle types.

Furthermore, it must be noted that electric motors for vehicle drives often operate using high voltages of a few hundred volts, and the rechargeable battery units in electric vehicles comprising such drives have a correspondingly high terminal voltage. In order to charge such units, charging stations must be provided which have correspondingly high output and considerable current uptake, in particular to ensure short charging times. If there is a large number of different rechargeable battery types, then suitable charging stations must be provided for each rechargeable battery type.

Finally, it must be noted that a considerable amount of heat is released when rechargeable batteries are charged. Typically, this heat is not only lost, but, if conditions are unfavorable, can also greatly stress the rechargeable battery and pose a safety and fire risk, in particular if a large number of rechargeable batteries are charged within a tight space, which can be the case at filling stations which are equipped to provide freshly charged rechargeable batteries, to exchange used rechargeable batteries and charge them in a charging device.

A problem addressed by the present invention is therefore that of providing a charging station, a method for the operation thereof, and a supply station which satisfactorily solve the above-described problem, in particular that of improving the heat management associated with the charging and storage of the rechargeable batteries.

The above-mentioned problem is solved by the features of the independent claims. Advantageous developments of the invention are the subject matter of the dependent claims.

According to the invention, a charging device for electric energy stores comprises a holding device which is designed and equipped to accommodate one or a plurality of electric energy stores, preferably rechargeable electric energy stores for vehicles, a charging and charge control device which is designed and equipped to charge, in a controlled manner, the electric energy store(s) accommodated in the holding device, and an air conditioning device which is designed and equipped to control the temperature inside the holding device, wherein temperature-controlled air is supplied to the inside of the holding device, and is characterized in that the air conditioning device is designed and adapted to adjust the air inside the holding device to the surrounding conditions with respect to the dew point.

An electric energy store within the scope of the invention refers to a device which is also designed and equipped to output electric energy, wherein the energy can be stored in one or more storage cells. A storage cell can comprise, in particular, although not exclusively, electrochemical or galvanic cells of the secondary type (so-called rechargeable batteries which, when fully or partially discharged, can be recharged by way of an electrochemical reaction by supplying electric charges, i.e. electric energy). Storage cells within the scope of the invention can comprise an active part in particular, within which charging and discharging processes and, optionally, electric energy conversion processes can take place, and which is enclosed by a film-like casing, for example, preferably in a gas-tight and fluid-type manner. The active part can comprise stacks or film layers made of electrochemically active materials, conductive materials and separating materials. So-called current collectors protrude out of the interior of the active part, where they are conductively connected to electrode regions, through the casing toward the outside of the cell, and permit connection of the active part of the cells to one another or a consumer. As is common in automotive technology, a battery is also understood to refer to a rechargeable battery, i.e. an electric energy store of the secondary (rechargeable) type, within the scope of the present application.

“Accommodate”, within the scope of the invention, refers to a process or state in which an object—an electric energy store in particular in this case—is also set down and remains in place permanently or temporarily. Allocation to a certain site of accommodation or storage can be provided. The accommodation takes place, for example, in or on shelves, compartments or other storage locations, preferably within a bounded space. The holding device can be thermally insulated overall.

“Charging an electric energy store” is understood to mean, within the scope of the invention, a process wherein energy in the form of electric charges is also supplied to an electric energy store or a storage cell, whereby a charge displacement takes place within the electric energy store or the storage cell(s), in particular by way of an electrochemical reaction, in such a way that energy in the form of electric charges, i.e. electric current, can be drawn once more by connecting an electric consumer.

“Charging in a controlled manner” is understood to mean, within the scope of the invention, charging while adhering to specified or specifiable charge parameters such as charging voltage, charging current and the like, wherein state parameters such as temperature, voltage, state of charge of the electric energy store or the storage cells is preferably monitored and, optionally, taken into account, and maintained as needed. The term “control” can also refer to “regulation”.

“Air conditioning” within the scope of the invention is intended to mean changing the state values of air. Preferably the state values are controlled or regulated to specified or specifiable setpoint values. “Temperature control” within the scope of the invention is intended to mean changing the temperature or setting a specified or specifiable temperature.

An “inside” within the scope of the invention is intended to mean the interior of an enclosed space, wherein the enclosure can comprise delineation as well as, preferably, thermal insulation with respect to the surroundings. An enclosure can be complete and include all sides, although this is not necessary. In the case of a storage space which is otherwise insulated, for example, an opening which forms a gap in the enclosure can be provided for the loading and removal of electric energy stores. It is also possible to provide one opening for loading and one opening for removing electric energy stores. Such openings can be separated from the surroundings, e.g. by way of a strip-type curtain, to prevent intensive air exchange with the surroundings. In a compartmentalized shelf system which is otherwise insulated all the way around, it is also possible, for example, to provide an opening on the front side for loading or removing one electric energy store. In the latter case, flaps, for example, which are folded back to permit an electric energy store to be housed, can provide separation from the surroundings when the compartment is not in use.

“Surroundings” within the scope of the invention refers to everything located outside of a space under consideration, preferably the free atmosphere, or a space within which the space under consideration is located. For example, a plurality of climate chambers or compartmentalized shelf systems, as holding devices for electric energy stores, can be located within a larger building. In this case, the inside of the building can be understood to be the surroundings of the climate chambers or compartmentalized shelf systems, or the surroundings of the building itself.

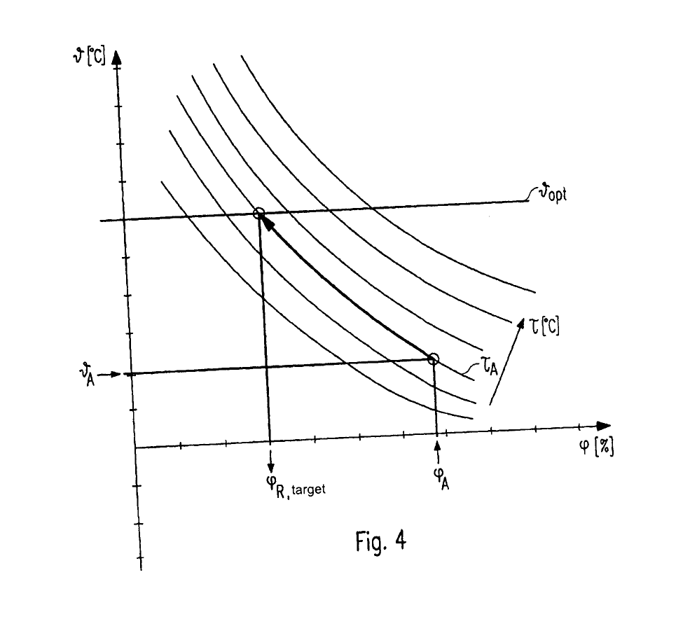

A “dew point” within the scope of the invention is understood to be the dew point of water in air. It is the state in which condensate first forms on an object exposed to moist air. The dew point, therefore, is precisely the point at which a relative humidity (air humidity) of 100% is reached. For each value pair of temperature and relative humidity, there is a uniquely certain value pair of pressure and temperature which indicates the dew point. Although, strictly speaking, the dew point is a value pair of temperature and pressure, in this case the dew point is equated to the temperature value of the dew point, the dew point temperature, as in the generally common manner. This relationship can be presented in table form or can be plotted in the form of diagrams. FIG. 4 shows a family of curves, wherein the relative humidity is selected as the x-axis, the air temperature is selected as the y-axis, and each curve corresponds to a constant value of the dew point temperature.

If, as provided according to the invention, the air conditioning device is designed and adapted to adjust the air inside the holding device to the surrounding conditions with respect to the dew point, it is also possible to prevent dew point crossings and problems associated therewith.

The air conditioning device can comprise an air supply device which is designed and equipped to supply air. An “air supply device” within the scope of the invention is understood to be a device which is also capable of conveying air in the direction of the holding device. Examples of air conveyance devices, such as ventilators of various types, for example, are well known in air conditioning technology. The air conditioning device can comprise a temperature-control device which is designed and equipped to cool and/or heat the supplied air. A “temperature-control device” within the scope of the invention is understood to be a device which is capable of heating or cooling—or both—air, in particular air which is flowing through. Examples of heating devices and cooling devices, and for combined devices of various types are well known in air conditioning technology. The air conditioning device can comprise a conditioning device which is designed and equipped to humidify and/or dehumidify the supplied air. A “conditioning device” within the scope of the invention is understood to be a device which is also capable of humidifying or dehumidifying—or both—air, in particular air which is flowing through. Examples of humidifying devices and dehumidifying devices, and for combined devices of various types are well known in air conditioning technology. The air conditioning device can comprise a control device which is designed and equipped to control the air supply device, the temperature-control device and the conditioning device. A “control device” within the scope of this invention is understood to mean a device which is also capable of processing data which has been entered and, on the basis thereof, to control external devices, i.e. to trigger certain actions. An actuator of the device can be influenced directly, or a setpoint value to be achieved by the device can be supplied to the device. Any data processing device which comprises at least one computing section, one memory section, and one input/output section can be used as the control device. By way of this design, it is also possible to effectively achieve specific air conditioning, i.e. the conveyance, temperature-control and conditioning of air. The air supply device, the temperature-control device and the conditioning device, and, optionally, the control device, can be accommodated in a common housing, whereby a compact design can also be ensured.

The charging device can comprise a measuring device, wherein the measuring device comprises a plurality of sensors which are designed and equipped to measure the temperature and the humidity of the surrounding air and/or the air introduced into the air conditioning device, and the temperature and the humidity of the indoor air inside the holding device, and/or the air directed out of the holding device, and to output corresponding measurement signals to the control device, wherein the control device is designed and equipped to control the supply device, the temperature-control device and the conditioning device, on the basis of at least a portion of the measurement signals, in such a way that it controls the temperature of the air supplied thereto such that the indoor air inside the holding device maintains a predetermined setpoint temperature, and conditions the air supplied thereto such that the dew point temperature of the indoor air inside the holding device corresponds to the dew point temperature of the surrounding air. A “sensor” within the scope of the invention is understood to be a component which is also capable of detecting a physical property, although not exclusively of one medium. Temperature sensors and humidity sensors are meant in particular, although not exclusively, within the scope of the inventions. They can be room sensors, outside sensors, duct sensors or container sensors. Within the scope of the invention, a measurement signal is understood to be an electric, optical or otherwise perceptible signal which carries information which permits the measured value of a physical property to be deduced. By way of such a design, it is also possible to effectively regulate the state variables of the air inside the holding device.

The charging device can be designed and equipped to determine setpoint values of air to be supplied to the inside of the holding device with respect to temperature, humidity and quantity, and to control the supply device, the temperature-control device and the conditioning device such that the air supplied to the inside of the holding device has the setpoint values that were determined, wherein the measuring device preferably comprises further sensors which are designed and equipped to measure the temperature and the humidity of the air supplied to the inside of the holding device, and to output corresponding measurement signals of the control device. “Determine” within the scope of the invention is understood to be a process which ascertains the information to be determined, whether it be by way of calculation, comparison, external input, query from a data base, or another manner. By way of such a design it is also possible to simplify the control with respect to the state variables of the air.

Sensors can be provided at different locations inside the holding device to measure the temperature and the humidity of the air at the various locations inside the holding device and output corresponding measurement signals to the control device. In this manner it is possible to check the measurements of the sensors for consistency and conclusiveness, a suitable mean value can be calculated, and the effectiveness of the control can be evaluated on the basis of a gradient of the measured variables, which was determined, beyond the entire inside of the holding device, and adherence to specified temperature limits throughout the entire inside of the holding device can be checked, and, optionally, the setpoint values for the temperature and/or the air quantity in particular can be adapted.

The control device can be designed and equipped to automatically determine an optimal value for the temperature on the basis of a type of the electric energy store contained in the holding device, and to define the optimal value as the setpoint value for the temperature of the indoor air inside the holding device. A type of energy store can be understood within the scope of the invention to be a unique designation—which is established by reference to an industry standard, for instance—of an electric energy store from a certain manufacturer, a certain model series, a certain production lot, etc., or, within the scope of the invention, a type of energy store can be understood to be coded information on the properties and parameters of the energy store, containing e.g. the type of electrochemical charging and discharging reaction, the material used, the number of cells, cell voltage, required or permissible charge current, required or permissible charge voltage, permissible temperature ranges or others. If an optimal value for the temperature is determined automatically on the basis of a type of electric energy store contained in the holding device, and the optimal value is defined as the setpoint value for the temperature of the indoor air inside the holding device, then flexible and operationally reliable control of the temperature profile within the holding device is possible in a particularly easy manner; the operating parameters of the charging device can be utilized across the entire range, depending on the situation.

In one embodiment of the invention, the holding device comprises a plurality of compartments which are separated from one another preferably thermally and with respect to fire safety in particular, wherein sensors of the measuring device are provided in each compartment in order to measure the temperature and the humidity of the air at at least one location inside each compartment and output corresponding measurement signals to the control device. In this manner the operational reliability of the entire charging device can be increased further.

It can be advantageous if each of the compartments is designed and equipped to accommodate a previously specified type of electric energy store or a plurality of types of electric energy stores, to which the same optimal temperature and/or the same permissible temperature range is assigned. By way of such a design it is also possible to even out the temperature profile within the holding device. It can be provided, for example, that compartments containing electric energy stores which have a low permissible charging temperature are located near an entry region of the conditioned air, while compartments containing electric energy stores which have a higher permissible charging temperature are located closer to an outlet region of the outgoing air. It is therefore also possible to advantageously utilize the temperature gradient within the course of the flow path inside the holding device.

It can be particularly advantageous if each of the plurality of compartments has a separate air supply, wherein the control device and the air conditioning device are designed and equipped to air-condition the plurality of compartments individually or in groups separately from one another. In this manner the operating parameters of the charging device can be optimized in an even more targeted manner.

It is particularly advantageous with respect to the energy balance of the entire system if the heat generated inside the holding device is stored or used or utilized directly. This can take place, for example, although not exclusively, in that the heat generated inside the holding device is supplied to a district heating network, the heat generated inside the holding device is supplied to a heat exchanger, the heat generated inside the holding device is used to heat supply water or to operate or support a local heating system, or the heat generated inside the holding device is used to preheat the air introduced into the air conditioning device.

The heat generated inside the holding device can be withdrawn particularly efficiently from the outgoing air directed out of the holding device.

A further aspect of the invention relates to a supply station for supplying at least partially electrically operated vehicles comprising rechargeable electric energy stores, which has a charging device of the type described above. A “supply station” within the scope of the invention is understood to mean a facility at which exhausted electric energy stores can be dropped off and charged electric energy stores can be picked up. A supply station can also comprise devices for charging electric energy stores which remain in vehicles, although this is not necessary.

A further aspect of the invention relates to a method for charging rechargeable electric energy stores, comprising the steps: Accommodate one or a plurality of electric energy stores, preferably rechargeable electric energy stores for vehicles, in a holding device; charge, in a controlled manner, the electric energy store(s) accommodated in the holding device; control the temperature inside of the holding device, characterized in that the air inside the holding device is adjusted to the surrounding conditions with respect to the dew point.

A further aspect of the invention relates to a method for charging rechargeable electric energy stores, comprising the steps: Accommodate one or a plurality of electric energy stores, preferably rechargeable electric energy stores for vehicles, in a holding device; charge, in a controlled manner, the electric energy store(s) accommodated in the holding device; control the temperature inside of the holding device, characterized in that the heat generated inside the holding device is stored or used or utilized directly.

The aforementioned and further features, objects and advantages of the present invention will become much clearer from the following description which refers to the attached drawings. In the drawings:

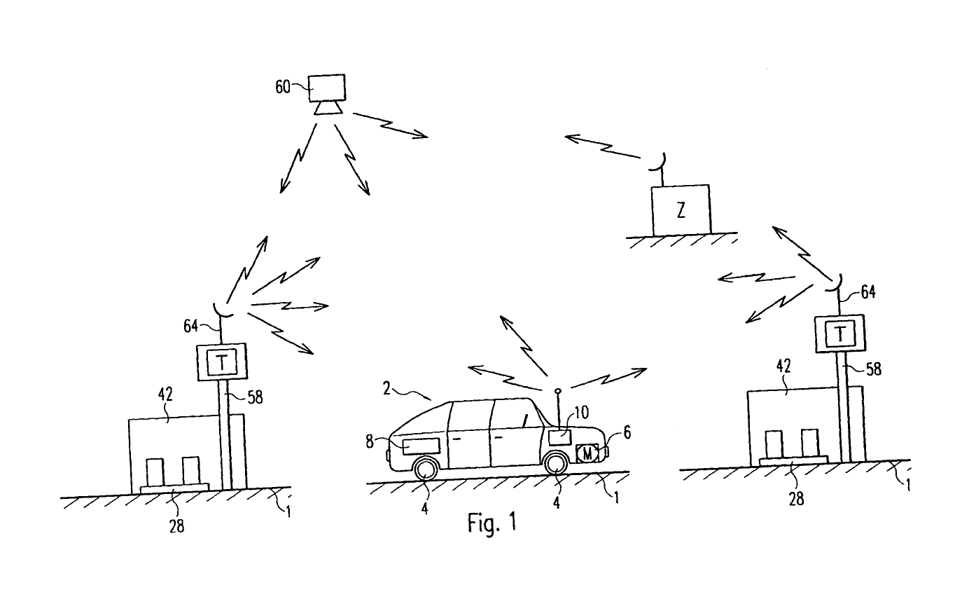

FIG. 1 is a schematic depiction of an infrastructure for supplying vehicles with rechargeable and exchangeable batteries, according to the invention;

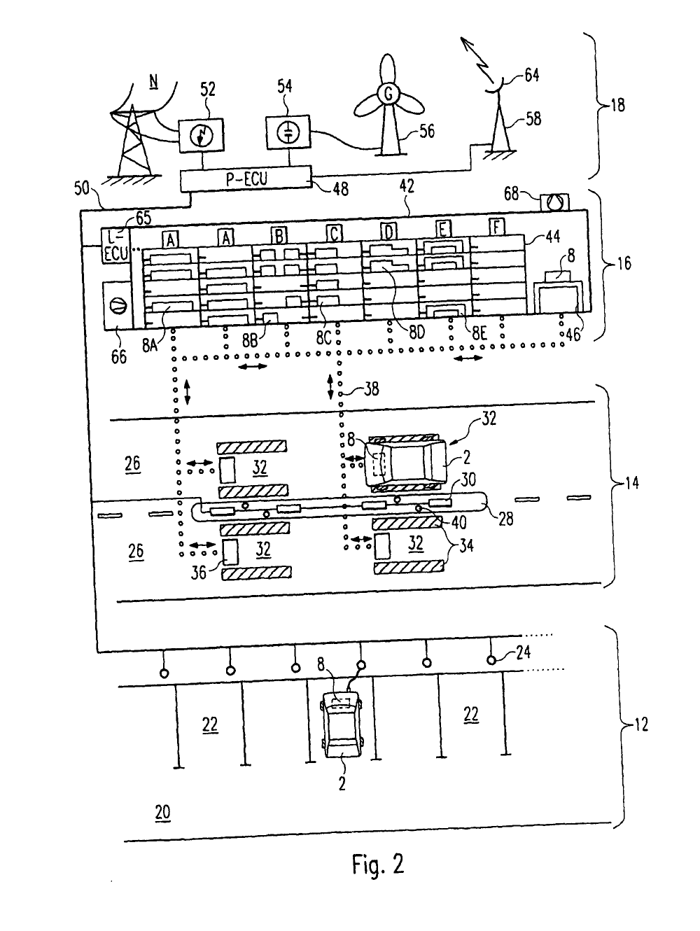

FIG. 2 is a schematic depiction of a filling station according to the invention;

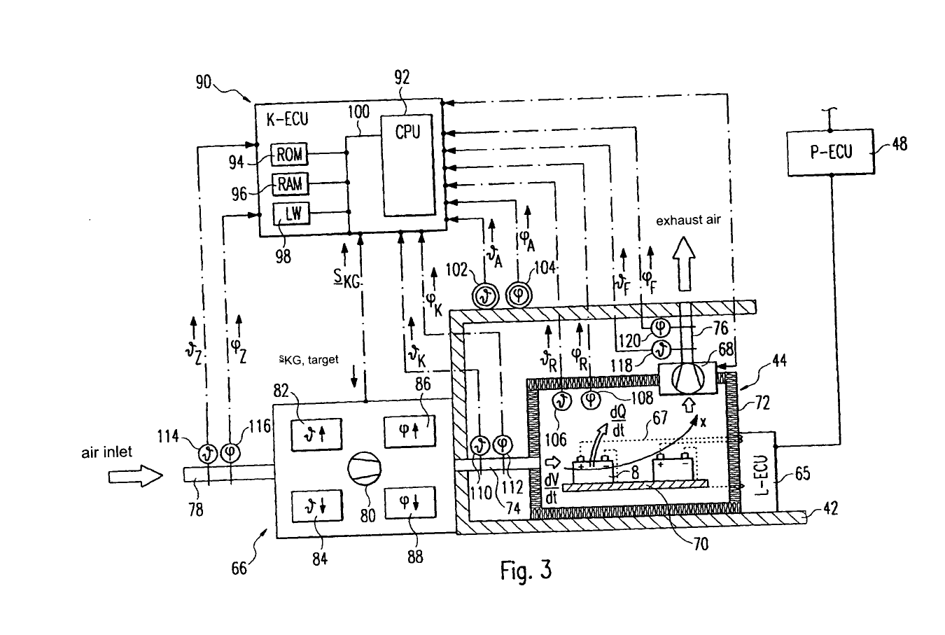

FIG. 3 is a schematic depiction of a battery charger according to a first embodiment of the invention;

FIG. 4 is a diagrammatic depiction for illustrating an air temperature control and conditioning process according to the invention; and

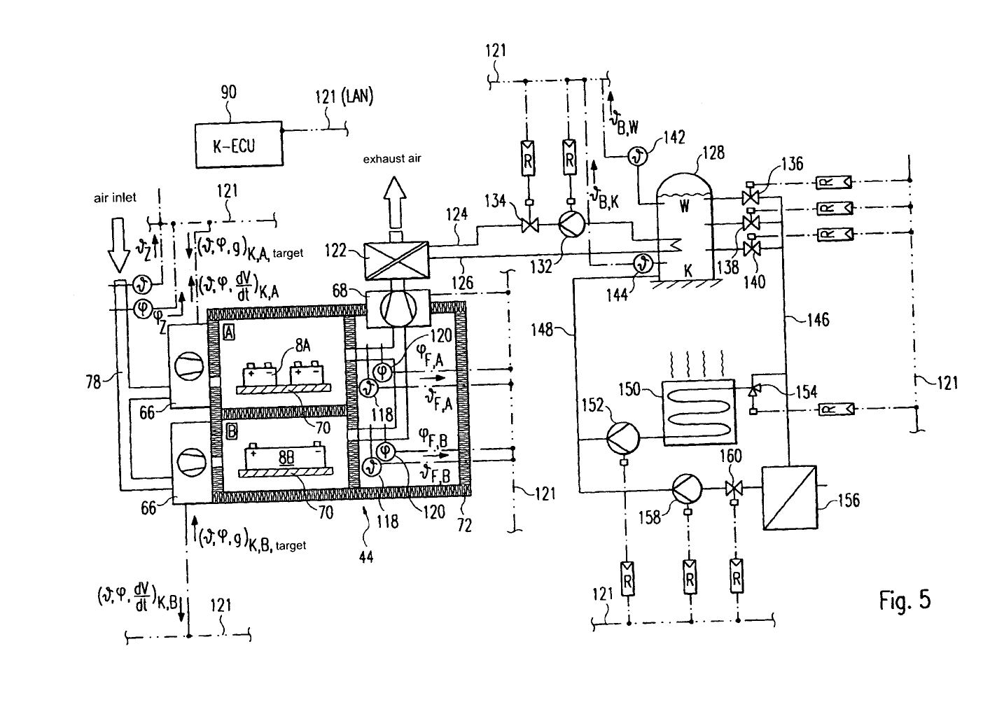

FIG. 5 is a schematic depiction of a battery charger according to a second embodiment of the invention, including an air conditioning device.

It is pointed out that the depictions in the figures are schematic and are limited to showing the features which are the most important for understanding the invention. It is also pointed out that the dimensions and ratios of sizes depicted in the figures are provided merely to clarify the depiction and should in no way be understood to be limiting or mandatory, unless indicated otherwise on the basis of the description that follows. In particular, dimensions in one spatial direction can be depicted such that they are exaggerated, in part, relative to other spatial directions in the drawings.

FIG. 1 shows, schematically, a configuration of an infrastructure by way of example, in which the present invention can be used to advantage. A vehicle 2, as a representative of a large number of vehicles, drives on a road network 1. A large number of filling stations “T” are set up on the road network 1, which are explained substantially according to the depiction in FIG. 2 and the associated drawing. The infrastructure also includes a satellite 60 of a satellite communication network (which can be provided by an external supplier) and a management center “Z”.

The filling stations T comprise rechargeable battery charging stations and rechargeable battery exchange stations, which are explained in greater detail in the following; gas pumps for conventional fuels can also be provided there.

According to the schematic depiction in FIG. 1, the vehicle 2 comprises four wheels 4, an electric motor 6 and a battery 8. At least two of the wheels 4 (the front wheels in this case) can be driven by the electric motor 4. A battery or a rechargeable battery 8 delivers the electric energy for driving, which is transferred by a vehicle control device (V-ECU) 10 to the electric motor(s) 6. The electric motor 8 can be in the form of a motor-generator which generates electric current in an overrun condition and supplies it to the battery 8 as charging current. In addition to the electric motor 8, an internal combustion engine for driving the vehicle and/or for charging the battery by way of the electric motor 8 which functions as a generator can be present.

In this case, the rechargeable battery 8 should be designed as a lithium ion rechargeable battery, a lithium polymer rechargeable battery or the like. Types of rechargeable batteries having a different electrochemical basis are also feasible, such as lead-gel rechargeable batteries, nickel-cadmium rechargeable batteries or others. It is also possible to provide two or more rechargeable batteries. The rechargeable battery 8 can comprise a plurality of parts.

The rechargeable battery 8 is designed to be exchangeable. It can be released manually, optionally as a module, or automatically in entirety, or can be removed or inserted in a modular manner. The contacting preferably takes place in a form-fit manner in one working step upon installation. Dangerous voltage levels can therefore be avoided as a matter of principle. At the same time, mechanical, electric or other fuses, such as in the contacting region of the module, are also released, thereby enabling the rechargeable battery 8 to be safely removed from the system and to be shipped in accordance with safety and transport requirements, e.g. if the rechargeable battery part is tested by the charging station and found to be defective (see below).

The rechargeable battery 8 is charged without the accompanying charging system, although it has a suitable battery management system at the module level, which can be operated by a higher-order master or by way of the energy management of the vehicle.

The filling stations T each have at least one service pylon 28 and at least one rechargeable battery charging and storage building 42, the design and function of which will be explained in greater detail at the given point.

The vehicle control device (the V-ECU) 10 can communicate with the radio devices 56 of the filling stations T by way of an antenna 62 of the vehicle 2 and antennas 64 of the filling stations T. The communication can also take place by way of the satellites 60 which serve as relay. The V-ECU 10 and the radio device 56 of the filling stations T can communicate with the management center Z, likewise by way of the satellite relay. In this manner, data on the position of a vehicle, the state of charge of the battery 8 of the vehicle, and the position of filling stations and the inventory thereof can be exchanged and used to guide the vehicle or a large number of vehicles for the storage and charging logistics of the filling stations and the like.

FIG. 2 is a schematic depiction of the design of a filling station according to the invention. The filling station T is divided into a self-charging zone 12, an exchange zone 14, a storage zone 16 and an energy management zone 18.

The self-charging zone 12 comprises an approach path 20 and a plurality of charging stations 22. An automated charging device 24 is assigned to each charging station 22. The automated charging device 24 is in the form, for example, of a column or a box or the like and comprises at least one outlet box for a charging cable or a permanently installed charging cable. The automated charging devices 24 are designed for rapid charging with high output, although they can also manage low charging outputs for gentle charging. If a vehicle 2 is located in a charging station 22, the rechargeable battery or the charge management system thereof is connected to the associated automated charging device 24 by way of a cable. The type of charging procedure is selected or determined automatically at the automated charging device 24 on the basis of the type of rechargeable battery. Payment can be made directly using cash or by way of check or credit card directly at the automated charging device 24 or at a separate payment point, or automatic deduction from a subscription account can take place on the basis of user identification to be performed at the automated charging device 24.

The exchange or replacement zone 14 comprises a two-lane approach path 26 and a service pylon 28. A total of four self-service control devices 30 are disposed on the service pylon 28. The self-service control devices 30 are each assigned to one of four exchange stations 32 provided on either side of the service pylon 28. (In a variant, it is possible to provide only one self-service device 30 for a plurality of exchange stations 32 )

Each exchange station 32 has two parking marks 34 and one exchange pit 36. The exchange pit 36 is located underground and can be closed for safety reasons using a drop-down or sliding door (not shown in detail) if a vehicle is not located on the exchange station 32. To exchange the rechargeable battery, a vehicle 2 is moved onto the parking marks 34 of an unoccupied exchange station 32. A robot (not shown in detail) is located in the exchange pit 36, which removes the rechargeable battery 8 of the vehicle from below, once it has released holding devices, connections and, optionally, covers. The rechargeable battery 8 is then transported to the storage zone 16 using a conveyor 38. From there, likewise using the conveyor 38, a fresh rechargeable battery 8 is transported into the exchange pit 36 and is installed into the vehicle 2 using the robot.

The parking marks 34 are simply marks painted onto the floor in this case. In a variant, however, the parking marks 34 can also comprise a conveyance device for positioning the vehicle 2 on the exchange station 32, as is known per se in the case of automated car washing systems, for example. The vehicle can be positioned automatically for the exchange process by way of such a conveyance device.

The self-service control devices 30 have a plurality of functions. In this case, an operator can submit identification and confirm an exchange process. Payment can also take place here. The self-service control device 30 also displays the progress or success or failure of the identification and exchange process.

For the case in which an exchange process fails, a charge connection 40 for every exchange station 32 is also disposed on the service pylon 28. The charge connections 40 are controlled by way of the self-service control devices 30. In contrast to the automated charging devices 24 in the charging zone, only rapid charging processes can take place at the charge connections 40 in the exchange zone 14, to prevent the exchange station 32 from being occupied for too long.

A compartmentalized shelf system 44 and a test station 46 are provided in the storage zone 16 in a storage building 42.

The compartmentalized shelf system 44 comprises a plurality of compartments A to E for rechargeable batteries of a plurality of types 8A to 8E, and one compartment F for flexible use. The test station 46 serves to check the rechargeable batteries 8 and either release them for storage in the compartmentalized shelf system 44, request maintenance or separate them out to be hauled away.

In the compartments of the compartmentalized shelf system 44, the rechargeable batteries 8 are connected to a charging system. The compartments of the compartmentalized shelf system 44 comprise outlets for this purpose, which correspond to the poles of the rechargeable batteries 8 and automatically establish contact therewith, preferably in a form-fit manner, upon placement therein. The rechargeable batteries 8 are therefore charged in the compartmentalized shelf system 44. A charge control device (L-ECU) 65 is provided for carrying out a suitable charging program and is connected to the charging system. The charging process is carried out automatically in accordance with the aspects of energy efficiency, safety and storage logistics. A permanent maintenance charge is preferably avoided for reasons of efficiency.

For safety reasons, the compartments A to F of the compartmentalized shelf system 42, and optionally even smaller parts, are shielded from one another with respect to fire safety. Furthermore, the entire storage zone 16 and the entire region of the conveyor 38 and the exchange pits 36 comprising a tub system are insulated with respect to penetration by any fluids which may emerge from the rechargeable batteries 8.

In the energy management zone 18, a central energy control device (P-ECU) 48 controls all processes within the filling station T and distributes the electric energy by way of a distribution network 50 to the particular consumers, in particular the automated charging devices 24 in the charging zone 12, the charge connections 40 in the exchange zone 14 and the L-ECU 65 in the storage zone 42. The L-ECU 65 can also be integrated in the P-ECU 48.

A transformer 52 receives electric energy from the district energy network “N” and converts it into usable voltage. Electric energy is buffered in an intermediate storage plant 54. A windmill 56 generates electric current from wind energy by way of a generator “G”.

The windmill 56 is only an example for local generation of electric energy. Depending on the geographic location, it is likewise possible to use a solar farm, a tidal or wave power plant, a water storage power plant, a running water generator, a geothermal generator or the like, in order to utilize regenerative energy sources. The electricity generated locally from regenerative energy sources is also buffered in the intermediate storage plant 54 if not used immediately, since it is not typically available on a continuous basis. In addition to regenerative power generation, it is also possible to provide a conventional power plant or an energy-based cogenerator.

A radio device 58 comprising antenna 64 is provided to enable communication with the management center Z, other filling stations T, a satellite network (indicated in FIG. 2 by way of a satellite 60) or vehicles 2, as described above.

The storage building 42 comprises an air conditioning device 66 for air conditioning the compartmentalized shelf system 44 and an extraction ventilator 68 for extracting the outgoing air. The mode of operation of the air conditioning device is explained in detail in the following.

FIG. 3 shows, schematically, the functional relationship between the storage building 42 and the compartmentalized shelf system 44 and the air conditioning device 66. For simplicity, the compartmentalized shelf system 44 is depicted with only one receiving compartment 70 for two rechargeable batteries 8, which are representative of the rechargeable batteries 8A to 8E in FIG. 2 and are connected by way of a charge conduction network 67 to the L-ECU 65 which carries out a suitable charging program.

The compartmentalized shelf system 44 has wall insulation 72 which thermally insulates the inside of the compartmentalized shelf system 44 with respect to the surroundings thereof. The air conditioning device 66 is installed outside the storage building 42 and is connected to the inside of the compartmentalized shelf system 44 by way of a connecting line 74. The air conditioning device 66 draws air out of the surroundings as intake air, brings it to the desired state values and delivers the air, as conditioned air, to the inside of the compartmentalized shelf system 44. An outgoing air ventilator 68 is built into the wall of the compartmentalized shelf system 44, by way of which an outgoing air line 76 is connected to an opening in the wall of the storage building 42 and delivers the outgoing air out of the inside of the compartmentalized shelf system 44 into the atmosphere.

The air conditioning device 66 comprises an intake air duct 78, a ventilator 80, a heating unit 82, a cooling unit 84, a humidifying unit 86 and a dehumidifying unit 88 which are accommodated in a common housing. Each of the units 82, 84, 86, 88 can comprise a plurality of individual devices or components, and a plurality of the units can be integrated in one component. A person skilled in the art has access to numerous air-conditioning components which he can select, design, locate, connect and assign in a suitable manner in accordance with his knowledge and ability, without a deeper explanation thereof being required within the scope of this application. Further devices for controlling and supplying the individual components with warm or cold water, steam or electric current, and suitable conveyance elements, supply and capture containers, control and regulation devices are omitted from the depiction and are used depending on need and suitability.

The air conditioning device 66 is controlled by a climate control device (K-ECU) 90 which is a common workstation computer or a specialized computing device. As the most important components, it comprises a central processing unit (CPU) 92, a read-only memory (ROM) 94, a main memory (RAM) 96, a magnetic or optical drive (LW) 98 (optional) and an internal bus 100 which connects the components of the climate control device 90 to one another. A hard drive or a suitable flash memory can be provided to expand the memory. An external interface (I/O interface) which is connected to the internal bus 100 is indicated by the border of the climate control device 90. The external interface is embodied by connection sockets or the like for connecting cables and a suitable bus for processing the incoming and outgoing data or signals. External input and output devices such as a keyboard, a mouse, a monitor, control lights or the like can be provided, although they are omitted from the depiction for simplicity.

The climate control device 90 is connected by way of signal lines (depicted in the figure as dash-dotted lines) to the air conditioning device 66 and the outgoing air ventilator 68, and to a large number of sensors. An outside temperature sensor 102 is located outside the compartmentalized shelf system 44 and is provided for measuring the temperature ∇_{A} of the outside air. An outside temperature sensor 104 is located outside the compartmentalized shelf system 44 and is provided for measuring the relative humidity φ_{A} of the outside air. A room temperature sensor 106 is located inside the compartmentalized shelf system 44 and is provided for measuring the temperature ∇_{R} inside the compartmentalized shelf system 44. A room temperature sensor 108 is located inside the compartmentalized shelf system 44 and is provided for measuring the relative humidity φ_{R} inside the compartmentalized shelf system 44.

A routine for controlling the air conditioning device 66 is stored in a memory region of the climate control device 90, which is executed by the CPU 92.

A first goal of the air conditioning is to maintain a certain optimal temperature ∇ₒₚₜ inside the compartmentalized shelf system 44. The optimal temperature is specified for a certain type of rechargeable battery or is defined as a mean value for a large number of rechargeable battery types. The optimal temperature can be entered manually or stored in advance in the RAM or the ROM of the climate control device or can be a component of the control routine. It is also feasible for the climate control device to utilize further parameters of the rechargeable battery 8, the state of charge or the charging program, the season of the year or other parameters to calculate the optimal temperature. The climate control device 90 therefore regulates the temperature inside the compartmentalized shelf system 44 to the optimal temperature ∇ₒₚₜ by controlling the air conditioning device 66 in a suitable manner.

In addition to temperature control, the control routine also performs humidity control and dew point control, and in so doing utilizes a relationship which is illustrated in FIG. 4. In the diagram shown in FIG. 4, the relative humidity φ of air is plotted on the x-axis and the air temperature Ε is plotted on the y-axis. For each value pair of relative humidity and temperature there is exactly one temperature precisely at which condensate forms on an object exposed to the humid air, that is, precisely at which a relative humidity of 100% is reached. This temperature is the dew point temperature |. In the diagram shown in FIG. 4, lines having a constant dew point temperature are drawn as a family of curves with | as the parameter. This relationship is known in theory and is symbolized by the equation

|=f(∇,φ) or (1)

φ=f⁻¹(|,∇) (1a)

wherein φ is the relative humidity in %, ∇ is the air temperature in ° C. and | is the dew point temperature in ° C., and whereby, furthermore, f is a function which provides a value for | when ∇, φ are given, and f⁻¹ is an inverse function of the function f which provides a value for φ when |, ∇ are given. This functional relationship is stored in the control routine or a separate memory region as a function or a value table.

The objective of dew point control is to ensure that the air inside the compartmentalized shelf system 44 is adjusted to the outside air with respect to the dew point (more precisely: the dew point temperature |). This adjustment is carried out as follows.

On the basis of the outside temperature and humidity ∇_{A}, φ_{A} measured by the sensors 102, 104, the climate control device 90 first determines the dew point temperature |_{A} of the outside air according to the equation

|_{A}=f(∇_{A},φ_{A}) (2)

having the conditions

∇_{R,soll}=∇ₒₚₜ (3)

|_{R,soll}=|_{A} (4)

wherein ∇_{R,soll} is the setpoint value for the air temperature inside the compartmentalized shelf system 44, and |_{R,soll} is the setpoint value for the dew point temperature of the air inside the compartmentalized shelf system 44, the climate control device 90 determines the setpoint value φ_{R,soll} for the relative humidity inside the compartmentalized shelf system 44 using the equation

$$\begin{matrix}{ϕ}_{R , soll} = {f}^{- 1} ( {\vert}_{R , soll} , {∇}_{R , soll} ) \\ = {f}^{- 1} ( {\vert}_{A} , {∇}_{opt} ) \\ = {f}^{- 1} ( f ( {∇}_{A} , {ϕ}_{A} ) , {∇}_{opt} ) .\end{matrix} \qquad ( 5 )$$

(The control routine refers only to the first line of equation (5); the second and third line of equation (5) serve only to illustrate the parameters upon which φ_{R,soll} ultimately depend.)

Proceeding therefrom, the climate control device 90 controls the air conditioning device 66 in such a way that the temperature ∇ₒₚₜ is achieved inside the compartmentalized shelf system 44, and the air inside the compartmentalized shelf system 44 is adjusted to the outside air with respect to the dew point. These processes are explained in greater detail in the following.

As shown in FIG. 3, the air leaves the air conditioning device 66 having a temperature ∇_{K} and a relative humidity φ_{K} at a volumetric flow rate of dV/dt and is supplied to the inside of the compartmentalized shelf system 44 as conditioned air. This conditioned air mixes at least partially—depending on the air flow guidance—with the indoor air present there, and partially displaces the indoor air present in the interior space. Furthermore, a heat flow dQ(x,t)/dt from the rechargeable batteries 8, which are located at different points x and have different states of charge, is supplied to this mixture. As a result, a new state of the indoor air is achieved, with a temperature ∇_{R} and a relative humidity φ_{R}.

From the perspective of control technology, the space inside the compartmentalized shelf system 44, including the heat-emitting rechargeable batteries 8, forms a system having a transfer function Ü_{FR}, wherein the transfer function Ü_{FR} of the compartmentalized shelf system 44 indicates which temperature ∇_{R} and relative humidity φ_{R} are achieved inside the compartmentalized shelf system 44 when conditioned air having a temperature ∇_{K} and a relative humidity φ_{K} is supplied to the space inside the compartmentalized shelf system 44 at a volumetric flow rate dV/dt. The transfer function Ü_{FR} of the compartmentalized shelf system 44 is not known at an arbitrary point in time. (It should be mentioned, however, that, assuming that no moisture is supplied to the space inside the compartmentalized shelf system 44 except for the quantity of water contained in the conditioned air, and assuming that no moisture is withdrawn except for the quantity of water contained in the outgoing air, the relative humidity φ_{R} of the space inside the compartmentalized shelf system 44 necessarily results on the basis of the temperature ∇_{R} achieved there and the total quantity of water contained in the indoor air, due to the physical law that warm air can absorb more moisture than cold air.) The formal expression, therefore, is:

(∇_{R}, φ_{R})=Ü_{FR} (∇_{R}, φ_{R}, dV/dt, ∇_{K}, φ_{K}) (6)

As mentioned previously, the transfer function Ü_{FR} of the space inside the compartmentalized shelf system 44 is not known at an arbitrary point in time. It is possible, however, to deduce the transfer function Ü_{FR} of the compartmentalized shelf system 44 on the basis of the current actual values of the temperature ∇_{R} and the relative humidity φ_{R} inside the compartmentalized shelf system 44. In particular, it is possible to define an approximated inverse function Ü_{FR}⁻¹ of the transfer function Ü_{FR} of the compartmentalized shelf system and, on the basis thereof, to determine suitable setpoint values for the temperature ∇_{K,soll}, the relative humidity φ_{K,soll} and the volumetric flow rate (dV/dt)ₛₒₗₗ of the conditioned air, in order to achieve the previously determined setpoint states inside the compartmentalized shelf system 44. This relationship can be expressed as follows:

**dV/dt)ₛₒₗₗ, ∇_{K,soll}, φ_{K,soll})=Ü_{FR}⁻¹ (═_{R}, φ_{R}, ∇_{R,soll}, φ_{R,soll}) (7)

On the basis of equation (7), the climate control device 90 therefore calculates the setpoint parameters (dV/dt)_{Soll}, ∇_{K,soll}, φ_{K,soll} for the conditioned air to be supplied to the compartmentalized shelf system 44.

The volumetric flow rate dV/dt forms a variable parameter which is used to optimize the thermal states and the energy balance.

If a ventilator 80 having a fixedly specified speed n is used in the air conditioning device 66, then, when the ventilator 90 is turned on, the volumetric flow rate (dV/dt)_{Ein} of the air conditioning device 66 that can be produced is basically unchangeable. In this case, using the volumetric flow rate dV/dt for optimization can be omitted, whereby the other devices and components of the air conditioning device 66, in particular the heating unit 82 and the cooling unit 84 may need to cover a broader control range.

However, if optimization on the basis of the volumetric flow rate dV/dt is not omitted at a specified, fixed volumetric flow rate (dV/dt)_{Ein} of the air conditioning device 66, then an arbitrary (mean) volumetric flow rate dV/dt can be achieved by turning the ventilator 90 on and off at intervals. If a starting current is supplied to the ventilator 80 as a square-wave signal which can assume only one specified maximum value (switched on) and 0 (switched off), then the so-called duty cycle g of the starting current is defined as

g=t_{Ein}/T (8)

wherein t_{Ein} is an ON period of the ventilator 80 and T is a period of the square-wave signal. The desired duty ratio is then determined as follows

gₛₒₗₗ=(dV/dt)ₛₒₗₗ/(dV/dt)_{Ein} (9)

It is understood that, when equation (7) is used in this case, the condition

(dV/dt)ₛₒₗₗ≦(dV/dt)_{Ein} (10)

must be taken into consideration. In other words, the volumetric flow rate that can be achieved overall by way of duty control cannot be greater than the switch-on volumetric flow rate of the air conditioning device 66.

The air conditioning device 66 as well forms a system having a transfer function Ü_{KG}, wherein the transfer function Ü_{KG} of the air conditioning device 66 indicates which temperature ∇_{K} and relative humidity φ_{K} the conditioned air has when outside air having a temperature of ∇_{A} and a relative humidity φ_{A} enters the air conditioning device 66 and flows therethrough at a volumetric flow rate dV/dt.

The transfer function Ü_{KG} of the air conditioning device 66 is known theoretically for all relevant states of the devices and components of the air conditioning device 66, wherein the states of the devices and components are determined by manipulated variables of the actuators thereof. If all state variables and manipulated variables of the devices and components of the air conditioning device 66 are combined in a state vector S_{KG}, the following applies:

(∇_{K}, φ_{K})=Ü_{KG} (S_{KG}, ∇_{A}, φ_{A}) (11)

The climate control device 66 has suitable adjustment routines in order to control the air conditioning device 66 in such a way that, when the states ∇_{A}, φ_{A} of the outside air are known, the conditioned air assumes a desired temperature ∇_{K,soll} and a desired air humidity φ_{K,soll} for a specified volumetric flow rate dV/dt. The adjustment routines can have suitable inverse functions of the transfer function Ü_{KG} or numerically evaluate the transfer function Ü_{KG} when adjustment parameters for the air conditioning device 66 are varied. If Ü_{KG}⁻¹ is an inversion or Ü_{KG}^{N} is a numerical evaluation of the transfer function Ü_{KG} of the air conditioning device 66, then the following applies:

S_{KG}=Ü_{KG}⁻¹ (∇_{K,soll}, φ_{K,soll}, ∇_{A}, φ_{A}) or (11a)

S_{KG}=Ü_{KG}^{N} (∇_{K,soll}, ^{SM}_{K,soll}, ∇_{A}, φ_{A}). (11b)

It should be noted that the volumetric flow rate dV/dt is given by a driving state, e.g. a variable starting current or the duty cycle g and a fixedly specified, maximum starting current of the ventilators 80 of the air conditioning device 66, and is therefore implicitly contained in the state vector S_{KG} of the air conditioning device 66.

In other words, the climate control device 90 controls the air conditioning device 66 in such a way that it delivers conditioned air from the supplied outside air, the parameters dV/dt, ∇_{K}, φ_{K} of which are adjusted such that the desired temperature ∇_{R}=∇_{R,soll}=∇ₒₚₜ and the desired air humidity φ_{R}=φ_{R,soll} are achieved inside the compartmentalized shelf system 44, with the requirement that the dew point temperature |_{R} inside the compartmentalized shelf system 44 corresponds to the dew point temperature |_{A} of the outside air.

In the embodiment shown, outside sensors 102, 104 deliver the temperature ∇_{A} and the relative humidity φ_{A} of the outside air. Alternatively or in addition to the outside sensors 102, 104, it is possible to provide intake air duct sensors 114, 116 for measuring temperature ∇_{z} and relative humidity φ_{z} of the intake air in the intake air duct 78 of the air conditioning device 66. The state parameters ∇_{Z}, φ_{Z} of the intake air can be used instead of the state parameters ∇_{A}, φ_{A} of the outside air in the control according to the above-noted equations (2) to (11).

The room sensors 106, 106 are disposed at a suitable point inside the compartmentalized shelf system 44. Since the state variables of the air, in particular the temperature ∇_{R} and, therefore, the relative humidity φ_{R}, inside the compartmentalized shelf system 44 change in the course of passing over a plurality of heat-emitting rechargeable batteries 8, several pair of room sensors 106, 108 can be provided to verify and/or average the measured values.

In addition or alternatively to the room sensors 106, 108, outgoing air duct sensors 118, 120 can be provided to measure temperature ∇_{F} and relative humidity φ_{F} of the air in the outgoing air duct 76. The state parameters ∇_{F}, φ_{F} of the outgoing air can be used in the control according to the above-noted equations (2) to (11) in addition to or instead of the state parameters ∇_{R}, φ_{R} of the air inside the compartmentalized shelf system 44, e.g. to achieve further verification or averaging.

The air guidance inside the compartmentalized shelf system 44 is designed such that the states of the conditioned air and the outgoing air mark the boundary states of the indoor air inside the compartmentalized shelf system 44, wherein the conditioned air corresponds to the lowest temperature and the highest relative humidity inside the compartmentalized shelf system 44, and the outgoing air corresponds to the highest temperature and the lowest relative humidity inside the compartmentalized shelf system 44. Therefore, the following applies:

∇_{K}≦∇_{R}(x)≦∇_{F} and (12)

φ_{K}≧φ_{R}(x)≧φ_{F} (13)

It is therefore possible to estimate, with great accuracy, the mean temperature and the mean relative humidity inside the compartmentalized shelf system 44, as follows:

∇_{R}(x=I/2)=(∇_{F}+∇_{K})/2 (14)

φ_{R}(x=I/2)=(φ_{F}+φ_{K})/2 (15)

wherein | is the total length of the path x of the air flow inside the compartmentalized shelf system 44 from the connecting channel 74 to the outgoing air duct 76. If an averaging of this type is carried out, optionally with a suitable weighting that is determined via experimentation or theoretically, then the use of indoor air sensors can be omitted under certain circumstances.

In addition or as an alternative to control on the basis of the optimal temperature □opt, the air conditioning can also be carried out in such a way that specified or separately determined temperature limits of the rechargeable batteries 8 that are accommodated can be maintained.

In the embodiment shown, the climate control device 90 is located separate from the air conditioning device 66. The climate control device 90 can also be a component of the air conditioning device 66, however. In a further variant, the climate control device 90 can calculate, instead of the setpoint values of the state vector S_{KG,soll}, only the setpoint parameters (dV/dt, ∇, φ)_{K,soll} (optionally g instead of dV/dt) for the conditioned air and supply them to the air conditioning unit 66, while a further control unit (not shown in greater detail) inside the air conditioning device 66 has the task of controlling the components of the air conditioning device 66 in such a way (i.e. calculating the adjustment values S_{KF} thereof in such a way) that the air conditioning device 66 delivers conditioned air having the required setpoint parameters. The climate control device 90 can also be part of the charge control device (L-ECU) 65 or the energy control device (P-ECU) 48, or vice versa.

In the embodiment shown, the air conditioning device 66 is installed outside the storage building 42 and is connected to the inside of the compartmentalized shelf system 44 by way of a connecting line 74. The location of the air conditioning device 66 is insignificant with respect to the usability of the invention, however. The air conditioning device can also be located inside the storage building 42, directly at the outside wall of the compartmentalized shelf system 44 or inside the compartmentalized shelf system 44 itself. The compartmentalized shelf system 44 or the compartments thereof can also be installed without a surrounding storage building.

It is also possible for a charging station comprising a plurality of manually loadable compartments to be set up on the side of the road in the manner of a self-service beverage machine, independently of the filling station shown in FIG. 2, wherein it is possible to take charged rechargeable batteries from the charging station and drop off discharged rechargeable batteries there. Such a charging station can comprise suitable means for identifying/verifying the exchanged rechargeable batteries, and suitable inventory-control mechanisms such as a bank card reading and verification device or the like.

In the embodiment shown, an outgoing air ventilator 68 is installed in the wall of the compartmentalized shelf system 44 and is connected to the surroundings by way of an outgoing air line 76 which leads into an opening in the wall of the storage building 42. The outgoing air ventilator 68 is optional, although it is necessary to achieve a predetermined flow path within the compartmentalized shelf system 44. Instead of a ventilator 80 inside the air conditioning device 66, it is also possible to utilize only the suction effect of the outgoing air ventilator 68.

In the embodiment shown, according to FIG. 3, the wall of the compartmentalized shelf system 44 comprises insulation 72, wherein the compartmentalized shelf system 44 is located inside the storage building 42. Alternatively or in addition thereto, the wall of the storage building 42 itself can comprise insulation.

In the embodiment shown, according to FIG. 2, the compartmentalized shelf system 44 is equipped with cabinets or compartments for various rechargeable battery types A to F, wherein the entire compartmentalized shelf system 44 is supplied with conditioned air by an air conditioning device 66. Furthermore, the compartmentalized shelf system 44 is depicted in FIG. 3 with only one receiving compartment 70 for two rechargeable batteries 8, which are representative of the rechargeable batteries 8A to 8E in FIG. 2. It is understood that the shelf division within the compartmentalized shelf system 44, in particular with respect to the number of cabinets, the division into compartments for different types of rechargeable batteries, etc., is insignificant with respect to the invention. In a variant, it is also possible for each compartment of the compartmentalized shelf system 44 to be thermally insulated from other compartments and to be supplied with conditioned air by a separate air conditioning device or a separate intake air path of an air conditioning device.

FIG. 5 shows a second embodiment of the present invention. This embodiment is identical to the embodiment described above except with respect to the deviating points explained in the following. It is therefore possible to apply the explanations provided for the previous embodiment and the variants thereof to the present embodiment to the fullest extent, provided they do not contradict the deviations described in the following. In particular, reference symbols that are identical to those used for the previously described embodiment refer to identical or analogous components. Components that were named and explained in the context of the previously described embodiment can be omitted and remain unmentioned, for simplicity; this does not rule out their presence, however. The considerations and variants with respect to the embodiment described below can also be transferred to the previous embodiment and the variants thereof, provided this is technically reasonable.

FIG. 5 shows the compartmentalized shelf system 44 having two compartments A and B for different rechargeable battery types 8A and 8B. The compartments A and B are separated from one another thermally and with respect to fire safety. The division into compartments can be used to allocate different rechargeable battery types or to better handle fire risks.

A separate air conditioning device 66 is assigned to each of the compartments A and B. Each of the air conditioning devices 66 is controlled by the climate control device 90. Duct sensors for determining the state parameters (∇_{K}, φ_{K})_{A} or (∇_{K}, φ_{K})_{B} of the particular conditioned air are integrated in the air conditioning devices 66. Both air conditioning devices 66 have a separate intake air line 78. Intake air lines comprising duct sensors 118, 120 disposed therein for determining the state parameters (∇_{F}, φ_{F})_{A} or (∇_{F}, φ_{F})_{B} lead into a common intake air line which leads into the outgoing air ventilator 68. Without loss of generality, the temperature ∇_{K,A/B,soll} and relative humidity φ_{K,A/B,soll} of the conditioned air and the duty cycle g_{A/B,soll} are supplied to the air conditioning devices as setpoint parameters, and in response they deliver, as actual parameters, the temperature ∇_{KA/B} and relative humidity φ_{K,A/B} and the volumetric flow rate (dV/dt)_{A/B}, as measured.

In this embodiment, the air conditioning devices 66 are each mounted directly on the wall of the compartmentalized shelf system 44, as discussed previously with respect to the above-described embodiment, as a variant. In this embodiment, the duct sensors 114-120 discussed in association with the previous embodiment, as an example, are provided for detecting the state parameters of the intake air and the outgoing air. The use of indoor air and outside air sensors should not be excluded as a result.

In contrast to the first embodiment, in this case, every sensor and every device is not connected to the climate control device 90 individually by way of a separate data or signal line; instead, a data bus 121 is provided, to which the climate control device 90 as well as all sensors, devices, controllers and the like are connected. The data bus 121 can be installed in a local area network (LAN), for example, by way of which the connected components can communicate with one another using a suitable protocol or a combination of a plurality of protocols such as HTTP, TCP/IP, UDP, ICMP, MPLS, wLAN, dLAN® or the like, including separately created protocols, and is depicted in the figure as a dash-double-dotted line.

Furthermore, an outgoing air heat exchanger 122 is connected downstream of the outgoing air ventilator 68. The outgoing air heat exchanger 122 is coupled to a heat store 128 by way of an advance line 124 and a return line 126. The heat store 124 is a container filled with a heat storage medium (typically water). A heat transfer line 130 extends through the heat store 128 on the cold side K (bottom) thereof, in such a way that the heat transfer surface is as large as possible (which is achieved, advantageously, by way of a serpentine or helical course of the heat transfer line), and comprises two connectors at which the advance line 124 and the return line 126 are connected. A heat transfer medium (typically water) circulates by way of a pump 132 through the heat recovery circuit formed by the outgoing air heat exchanger, the advance line 124, the return line 126 and the heat transfer line 130 of the heat store 128. The heat recovery circuit can be shut off by way of a shutoff valve 134. The pump 132 and the shutoff valve 134 can each be controlled by way of a controller (all controllers are labelled with the letter “R” here and in the following without any further reference symbols). The controllers are connected to the data bus 121, thereby enabling them to be operated by the climate control device 90.

In this manner, excess usable heat from the outgoing air is given off by way of the outgoing air heat exchanger 122 to the heat transfer medium circulating in the heat recovery circuit, and is given off by way of the heat transfer line 130 to the heat storage medium located in the heat store 128. Due to differences in density, the effect of gravitation causes a temperature stratification to set in such that a cold side is defined in the lower region of the heat store 128 and a warm side W is defined in the top region of the heat store 128.

The heat store 128 is connected to a heat utilization circuit in a manner known per se. The heat storage medium can be withdrawn from the heat store 128 at a plurality (three in this case) of points, each of which can be shut off by way of shutoff valves 136, 138, 140, which are distributed along the level of the heat store 128. The temperature stratification present at the time inside the heat store determines which of the shutoff valves 136, 138, 140 is open. The temperature stratification present at the time in the heat store 130 is determined by way of temperature sensors 142, 144 which are connected to the climate control device 90 by way of the data bus 121. The temperature sensor 142 is disposed in the top region of the heat store 130 and detects a container temperature in the warm region ∇_{B,W}, while the temperature sensor 144 is disposed in the bottom region of the heat store 130 and detects a container temperature in the cold region ∇_{B,K}.

The outlets of the shutoff valves 136, 138, 140 lead into a common advance line 146 of a heat utilization circuit. After supplying one or more user circuits, they converge in a common return line 148 of the heat utilization circuit which leads into the heat store 130 on the cold side. As examples of user circuits, FIG. 5 shows a heating circuit having a heater core 150, a pump 152 and a thermostat angle valve 154, and a warm water circuit comprising a heat exchanger 156, a pump 158 and a shutoff valve 160. The heat exchanger 156 can operate according to the once-through principle, for example, and heat service water or drinking water.

It is understood that the circuits and types of use depicted in the figure are examples which do not limit the potential applications in any way. The dissipated heat of the outgoing air can also be stored in a district heating network, for example, to heat indoor air directly (such as a retail or administrative building attached to the filling station), or for use in another manner. In addition, the heat store can be heated by way of other heat sources such as district heat, solar heat, geothermal heat, solar or wind current, an energy-based cogenerator or the like. Regenerative heating of the intake air of the air conditioning devices 66 can also take place by way of the heat in the outgoing air.

Within the scope of this description, all flow-mechanical control operating panels that switch or regulate a volumetric flow are referred to as a valve, regardless of the design. Taps, sliding elements, flaps, closing baffles and the like are therefore included in the term “valve” within the scope of this description. The shutoff valves described in association with the previous embodiment can be, for example, electromagnetically actuated switching valves or on/off valves (2/2 directional control valves), electric motor-actuated ball valves, locking slides that are actuated pneumatically, hydraulically or by way of a motor and rack, or the like. Instead of shutoff valves, it is also possible to use control valves or proportional valves, in particular although not exclusively in the thermostat angle valve 154 of the heating circuit.

The details of the design of the air conditioning device 66 were not explained within the scope of this application. It is understood that the air conditioning device 66 can comprise a large number of individual components which, in turn, can be components of control circuits which can contain, for example, hot water and/or cold water circuits including associated containers, vessels, valves, pumps and the control and actuating elements thereof, electric heating assemblies, evaporators including associated steam generators, etc., and more of the same, each of which is controlled by the climate control device 90 or individually associated control devices.

A portion of the components of the air conditioning device can be combined in a pre-air conditioning section which can comprise, for example but not necessarily exclusively, a multiflap shutter, an air filter, a surface cooler comprising a water collector, an outside air heat exchanger for preheating, which is connected to an outgoing air heat exchanger in the outgoing air flow by way of a water circuit, and a sound absorber. A post-air conditioning section can comprise, for example but not necessarily exclusively, a ventilator, a radiator, a spray humidifier, a mist collector, a heater and a further sound absorber. With respect to the previously described embodiment comprising a plurality of thermally mutually separated compartments of the compartmentalized shelf system 44, the post-air conditioning system can be present multifold, i.e. once for each compartment of the compartmentalized shelf system 44, while access is made to a common pre-air conditioning section.

As a supplement to the system, a type-detection device can be provided either in the compartmentalized shelf system 44 or at the maintenance station 46 or in the conveyor 38 or in the exchange pit 36 or at any other suitable location, which is designed and equipped to detect the types of rechargeable batteries 8 accommodated in the holding device. Such type detection makes it possible to use a suitable charging program, and the climate control device (K-ECU) 90 can determine the optimal value for the temperature ∇ₒₚₜ inside the compartmentalized shelf system 44 on the basis of the type of rechargeable batteries 8 accommodated there. For this purpose, a table can be stored in the ROM 94, the RAM 96 or on a data storage device in the disk drive 98, which enables optimal values to be assigned to a type of rechargeable battery, wherein the types listed in the table preferably include the types of rechargeable batteries 8 that can be accommodated in the compartmentalized shelf system 44. If a plurality of rechargeable battery types (8A to 8E) can be accommodated in a compartmentalized shelf system 44, a mean value of the optimal values corresponding to the types accommodated can be calculated as the optimal temperature ∇ₒₚₜ. Furthermore, the table can make it possible to assign permissible temperature ranges to the rechargeable battery types, and the climate control device 66 can be designed and equipped to define an approximated optimal value for the temperature inside the compartmentalized shelf system 44 by reference to the table in such a way that the permissible temperature ranges for the rechargeable batteries accommodated in the holding device are maintained.

A measurement of the volumetric flow rate of the air conditioning device(s) 66 can also simplify adherence to this parameter.

As a further supplement to the system, a device can be provided for disassembling electric energy store devices into modules, wherein the disassembly can be carried out manually by operators or in a semi-automated or fully automated manner. Disassembly of this type has the advantage that, instead of a large number of sizes and models of the rechargeable batteries 8A, . . . 8F to be taken into account, each of which is adapted to various vehicle models, a more manageable number of module sizes and module shapes must be taken into account. Therefore, fewer different compartment shapes need to be provided in the compartmentalized shelf system. The handling and cooling of smaller modules can also be easier than is the case with large blocks.

The wireless communication depicted in FIG. 1 and FIG. 2 can be replaced by wired communication, in particular without the use of a satellite communication system. Communication with the vehicle 2 is optional, although it can make sense, for example, for adjusting a charging program for stored rechargeable batteries if demand for the next rechargeable batteries to be required is determined by way of communication with the vehicle 2.

The rechargeable battery 8 can comprise a plurality of modules which are assembled and interconnected in a suitable manner depending on the demand and space available for a vehicle type. The rechargeable battery modules can each comprise a plurality of secondary cells. The secondary cells can be, in particular although not exclusively, flat cells having flat current collectors (poles) which project outwardly on opposite narrow sides. Advantageously, although not exclusively, the secondary cells can comprise electrochemically active materials which contain lithium (so-called lithium ion rechargeable batteries).

The invention was described above in the context of vehicle batteries of a four-wheel vehicle for a public road network. The usability of the invention is not dependent upon the type of vehicle or the number of wheels or axles or the driven wheels or the design of the drive train per se. As an alternative, all wheels 4 can be drivable by the electric motor 4. It is also possible for each drivable wheel to comprise a separate electric motor which, optionally, can be installed in the wheel or hub housing. The invention is equally applicable for passenger vehicles having two or three axles, trucks having two, three or more axles, motorcycles having wheels disposed one behind the other or next to one another, crawler vehicles, watercraft or aircraft. The invention is also applicable in conjunction with industrial systems if electric rechargeable batteries or other energy stores such as high-performance capacitors are charged. The use of the electric energy stores is not limited to vehicles, but rather can also be advantageous in the field of regenerative power plants for example, although not exclusively.

Devices disposed in the storage zone 12 (see FIG. 2) can be understood in entirety or in part as a charging device within the scope of the invention. The rechargeable batteries or batteries 8, 8A to 8E, or, optionally, the modules thereof, named within the scope of this description are electric energy stores within the scope of the invention. The compartmentalized shelf system 44 or the entire storage building 42 is a holding device within the scope of the invention. The air conditioning device 66 is an air conditioning device within the scope of the invention. The charge control device 65 and the charge conduction network 67 are a charging and charge control device in the sense of the invention. The air conditioning device 80 is an air conditioning device within the scope of the invention. The heating unit 82 and the cooling unit 84 form a temperature-control device within the scope of the invention. The humidifying unit 86 and the dehumidifying unit 88 form a conditioning device within the scope of the invention. It should be noted that the functions of the conditioning device and the temperature-control device are separated abstractly here; the functions of the air-conditioning-related components associated therewith can overlap and be assignable to the temperature-control device and to the conditioning device. The climate control device 90 is a control device within the scope of the invention. The temperature sensors 102, 106, 110, 114, 118 and the humidity sensors 104, 108, 112, 116 and 120 are measurement sensors within the scope of the invention and form, in part or in entirety, a measurement device within the scope of the invention. The setpoint value for the room temperature □_{R,soll} is a setpoint temperature within the scope of the invention. The outside air is ambient air within the scope of the invention. The intake air which, optionally, is identical to the outside air, is air introduced into the air conditioning device within the scope of the invention. The conditioned air is air supplied to the inside of the holding device within the scope of the invention. The volumetric flow rate dV/dT is a measure of an air quantity within the scope of the invention. The receiving compartment 70 or the position of a rechargeable battery 8 in the receiving compartment 70 (see FIG. 3 or 5) or a compartment A to F (see FIG. 2) or every individual compartment thereof or an arbitrary position within the compartmentalized shelf system 44 can be a location inside the holding device within the scope of the invention.

### LIST OF REFERENCE SYMBOLS

1 Road network

2 Vehicle

4 Drive wheel

6 Electric motor (M/G)

8, 8′ Rechargeable battery

10 Vehicle control device (V-ECU)

12 Self-charging zone

14 Exchange zone

16 Storage zone

18 Energy management zone

20 Approach path of 12

22 Charging station

24 Automated charging device

26 Approach path of 14

28 Service pylon

30 Self-service control device

32 Exchange station

34 Parking mark

36 Exchange pit

38 Conveyor

40 Charge connection

42 Rechargeable battery charging and storage building

44 Compartmentalized shelf system

46 Test station

48 Energy control device (P-ECU)

50 Distribution network

52 Transformer

54 Intermediate storage plant

56 Windmill

58 Radio device

60 Satellite

62 Antenna of 2 and 88

64 Antenna of T and 58

65 Charge control device (L-ECU)

66 Air conditioning device

67 Charge conduction network

68 Outgoing air ventilator

70 Receiving compartment

72 Wall insulation

74 Connecting channel

76 Outgoing air duct

78 Intake air duct

80 Ventilator

82 Heating unit

84 Cooling unit

86 Humidifying unit

88 Dehumidifying unit

90 Climate control device

92 CPU

94 ROM

96 RAM

98 Disk drive (LW)

100 Internal bus

102 Outside temperature sensor

104 Outside humidity sensor

106 Room temperature sensor

108 Room humidity sensor

110, 114, 118 Duct temperature sensor

112,116,120 Duct humidity sensor

121 External bus (LAN)

122 Outgoing air heat exchanger

124 Advance line

126 Return line

128 Heat store

130 Heat transfer line

132 Pump

134-140 Shutoff valves

142, 144 Container temperature sensor

146 Heat circuit advance line

148 Heat circuit return line

150 Heater core

152 Pump

154 Thermostat angle valve

156 Warm water heat exchanger

158 Pump

160 Shutoff valve

A to F Compartments of the compartmentalized shelf system 44

CPU Central arithmetic and processing unit

CTR Control device

ECU Electric/electronic control device or control unit

G Generator

K Cold side

K-ECU Climate control device

L-ECU Charge control device

LAN Local area network

LW Disk drive (magnetic, optical, etc., internal or external)

M Motor

N Network

P-ECU Energy control device

R Controller

RAM Main memory

ROM Read-only memory

T Filling station

V-ECU Vehicle control device

W Warm side

Z Central station

### LIST OF FORMULA SYMBOLS

| Dew point temperature in ° C.

φ Relative air humidity in %

∇ Temperature in ° C.

d . . . /dt Derivative with respect to time of . . . or . . . current

f Function (specifically in this case: dew point function)

g Duty cycle (also: pulse control factor or duty ratio)

l Total length of the air flow path

n Speed

t Time

x Path length of the air flow

S State vector (or, in general: state matrix) of manipulated variables

T Period of a square-wave signal

Ü Transfer function

V Volume

### LIST OF INDICES (SUBSCRIPT, UNLESS INDICATED OTHERWISE)

−1 Inverse of a function (superscript only)

A to F Compartments of the compartmentalized shelf system 44

A Outside air

B Container

On Switched on

F Outgoing air

FR Compartmentalized shelf system

K Conditioned air; cold side

KG Air conditioning device

Opt Optimal value

N Numerical evaluation of a function (superscript only)

R Indoor air

soll Setpoint value

W Warm side

Z Intake air

It is expressly pointed out that the lists of reference characters and formula symbols, and indices are an integral part of the description.

1-19. (canceled)

20. A charging device for electric energy stores, comprising:
a holding device configured to accommodate one or a plurality of electric energy stores, or rechargeable electric energy stores for vehicles;
a charge control device configured to charge, in a controlled manner, the electric energy store(s) accommodated in the holding device;
a conditioning device configured to humidify and/or dehumidify supplied air; and
an air conditioning device configured to air-condition an inside of the holding device,
wherein the air conditioning device and the conditioning device are configured to counteract condensation of air humidity inside the holding device.

21. The charging device according to claim 20, wherein the air-conditioning device comprises:
an air supply device configured to supply air;
a temperature-control device configured to cool and/or heat the supplied air;
a conditioning device configured to humidify and/or dehumidify the supplied air; and
a control device configured to control the air supply device, the temperature-control device, and the conditioning device.

22. The charging device according to claim 21, further comprising a measuring device, wherein the measuring device comprises a plurality of sensors configured to measure temperature and humidity of surrounding air and/or the air introduced into the air-conditioning device, and temperature and humidity of indoor air inside the holding device, and/or the air directed out of the holding device, and to output corresponding measurement signals to the control device,
wherein the control device is further configured to control the supply device, the temperature-control device, and the conditioning device, on the basis of at least a portion of the measurement signals, such that it controls the temperature of the air supplied thereto such that the indoor air inside the holding device maintains a predetermined setpoint temperature, and conditions the air supplied thereto such that dew point temperature of the indoor air inside the holding device corresponds to dew point temperature of surrounding air.

23. The charging device according to claim 22, wherein the control device is further configured to determine setpoint values of air to be supplied to the inside of the holding device with respect to temperature, humidity, and quantity, and to control the supply device, the temperature-control device, and the conditioning device such that the air supplied to the inside of the holding device has the setpoint values that were determined,
wherein the measuring device further comprises further sensors to measure temperature and the humidity of the air supplied to the inside of the holding device, and to output corresponding measurement signals to the control device.

24. The charging device according to claim 22, wherein the sensors are provided at different locations inside the holding device to measure the temperature and the humidity of the air at the various locations inside the holding device and output corresponding measurement signals to the control device.

25. The charging device according to one claim 21, wherein the control device is further configured to automatically determine an optimal value for the temperature on the basis of a type of the electric energy store contained in the holding device, and to define the optimal value as the setpoint value for the temperature of the indoor air inside the holding device.

26. The charging device according to claim 22, wherein the holding device comprises a plurality of compartments which are separated from one another thermally, wherein sensors of the measuring device are provided in each compartment to measure the temperature and the humidity of the air in at least one location inside each compartment and output these indicating measurement signals to the control device.

27. The charging device according to claim 26, wherein each of the compartments is configured to accommodate a previously specified type of electric energy store or a plurality of types of electric energy stores, to which a same optimal temperature and/or a same permissible temperature range is assigned.

28. The charging device according to claim 26, wherein each of the plurality of compartments has a separate air supply,
wherein the control device and the air-conditioning device are configured to air-condition the plurality of compartments individually or in groups separately from one another.

29. The charging device according to claim 20, wherein the heat generated inside the holding device is stored or used or utilized directly.

30. A charging device according to claim 22, comprising:
a holding device configured to accommodate one or a plurality of electric energy stores, or rechargeable electric energy stores for vehicles;
a charge control device configured to charge, in a controlled manner, the electric energy store(s) accommodated in the holding device; and
an air-conditioning device configured to air-condition the inside of the holding device, wherein heat generated inside the holding device is stored or used or utilized directly.

31. The charging device according to claim 30, wherein the heat generated inside the holding device is used to preheat the air supplied to the air conditioning device.

32. A supply station for supplying at least partially electrically operated vehicles comprising rechargeable electric energy stores, which has a charging device according claim 20.

33. A method for charging electric energy stores, comprising:
accommodating one or a plurality of electric energy stores, or rechargeable electric energy stores for vehicles, in a holding device;
charging, in a controlled manner, the electric energy store(s) accommodated in the holding device;
controlling temperature inside of the holding device,
wherein condensation of air humidity inside the holding device is counteracted.

34. The method according to claim 33,
wherein heat generated inside the holding device is stored or used or utilized directly.
